(19) United States
(12) Patent Application Publication
(10) Pub. No.: US 2025/0182468 A1
(43) Pub. Date: Jun. 5, 2025

(54) METHOD AND DEVICE FOR RECOGNIZING OBJECT

(71) Applicant: ELECTRONICS AND TELECOMMUNICATIONS RESEARCH INSTITUTE, Daejeon (KR)

(72) Inventors: Mi Jeong PARK, Sejong-si (KR); Jae Jin LEE, Daejeon (KR)

(21) Appl. No.: 18/955,070

(22) Filed: Nov. 21, 2024

(30) Foreign Application Priority Data
Dec. 1, 2023 (KR) 10-2023-0172068

(51) Int. Cl. G06V 10/94; G06V 10/82

(52) U.S. Cl. CPC G06V 10/955; G06V 10/82

(57) ABSTRACT

A method and a device for recognizing an object are disclosed. The object recognizing device includes an electrode array including a plurality of drive electrodes and a plurality of sense electrodes; a sensing circuit configured to generate a pulse train representing spatial information and material information on an object positioned over the electrode array based on mutual capacitances formed between the plurality of drive electrodes and the plurality of sense electrodes; and a neuron network processor configured to recognize the object positioned over the electrode array based on the pulse train.

### CROSS-REFERENCE TO RELATED APPLICATION

The present application claims priority to Korean Patent Application No. 10-2023-0172068, filed on Dec. 1, 2023, the disclosure of which is incorporated by reference herein in its entirety.

### BACKGROUND

### 1. Technical Field

The present disclosure relates to a method and a device for recognizing an object.

### 2. Description of Related Art

The content described below simply provides background information related to the present embodiment and does not constitute prior art.

A spike neuron network (SNN) is a neural network technology that processes signals based on spike signals, as a technology that mimics a biological mechanism in which actual neurons operate. In order to use the SNN, an input device that converts input data into spike signals is required.

Methods of receiving a spike input from an existing SNN include processing spike encoding on an image (e.g., MNIST) to obtain a spike and provide an input or a device of encoding image data that changes over time to generate a spike and input the same, such as a dynamic vision sensor (DVS). However, in order to capture an image for object recognition and perform spike encoding, an image having a resolution greater than MNIST (28×28) is required, and thus, the size and scale of an additional device for input processing may increase. In addition, since the DVS may process only images with changes, it has difficulty recognizing objects in a static state.

### SUMMARY

According to at least one embodiment, the present disclosure provides an object recognizing device. The object recognizing device may include an electrode array, a sensing circuit, and a neuron network processor. The electrode array includes a plurality of drive electrodes and a plurality of sense electrodes. The sensing circuit is configured to generate a pulse train representing spatial information and material information on an object positioned over the electrode array based on mutual capacitances formed between the plurality of drive electrodes and the plurality of sense electrodes. The neuron network processor is configured to recognize the object positioned over the electrode array based on the pulse train.

According to another embodiment, the present disclosure provides an operating method of an object recognizing device including an electrode array including a plurality of drive electrodes and a plurality of sense electrodes. The operating method includes generating a pulse train representing spatial information and material information on an object positioned over the electrode array based on mutual capacitances formed between the plurality of drive electrodes and the plurality of sense electrodes; and recognizing the object positioned over the electrode array from the pulse train using a neuron network.

According to yet another embodiment, the present disclosure provides a device of generating an input signal for recognizing an object based on a spike neuron network. The device includes an electrode array and a sensing circuit. The electrode array includes a plurality of drive electrodes and a plurality of sense electrodes. The sensing circuit is configured to generate a pulse train representing spatial information and material information on an object positioned over the electrode array based on mutual capacitances formed between the plurality of drive electrodes and the plurality of sense electrodes, and to provide the generated pulse train as an input of a device performing operation of the spike neuron network.

### BRIEF DESCRIPTION OF THE DRAWINGS

FIG. 1 is a block diagram schematically illustrating an object recognition device according to an embodiment of the present disclosure.

FIG. 2 is a diagram illustrating an electrode array according to an embodiment of the present disclosure.

FIGS. 3A and 3B are diagrams referenced to explain mutual capacitance formed between a drive electrode and a sense electrode according to an embodiment of the present disclosure.

FIG. 4 is a diagram schematically illustrating a drive circuit and a sensing circuit according to an embodiment of the present disclosure.

FIGS. 5A and 5B are waveform diagrams referenced to explain the operation of the drive circuit and the sensing circuit according to an embodiment of the present disclosure.

FIG. 6 is a diagram schematically illustrating a neuron network processor according to an embodiment of the present disclosure.

FIG. 7 is a diagram referenced to explain a neuron layer according to an embodiment of the present disclosure.

FIG. 8 is a diagram referenced to explain a neuron circuit according to an embodiment of the present disclosure.

FIG. 9 is a flowchart illustrating an operation of an object recognition device according to an embodiment of the present disclosure.

### DETAILED DESCRIPTION

The present disclosure may provide a method and device capable of generating a spike signal having spatial information and material information on an object from a mutual capacitance value formed in an electrode array using the characteristics of each object having a different shape and dielectric constant and recognizing an object based on the spike signal.

The present disclosure may provide a method and device capable of representing characteristics of an object at low resolution and generating data with spikes.

The features of the present disclosure are not limited to the features mentioned above, and other features not mentioned will be clearly understood by those skilled in the art from the description below.

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C).

Hereinafter, configurations and operations of embodiments will be described in detail with reference to the accompanying drawings. The following description is one of various patentable aspects of the disclosure and may form a part of the detailed description of the disclosure.

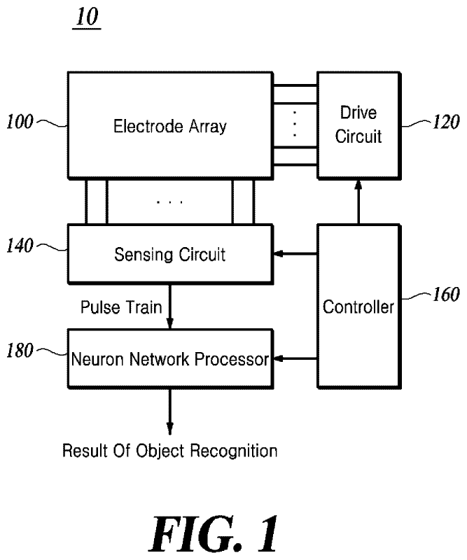

FIG. 1 is a block diagram schematically illustrating an object recognition device according to an embodiment of the present disclosure.

As shown in FIG. 1, the object recognition device 10 may include all or some of an electrode array 100, a drive circuit 120, a sensing circuit 140, a controller 160, and a neuron network processor 180. Not all blocks shown in FIG. 1 are essential elements, and some blocks may be added, changed, or deleted in other embodiments. Meanwhile, the components shown in FIG. 1 represent functionally distinct elements, and at least one component may be implemented in an integrated form in an actual physical environment.

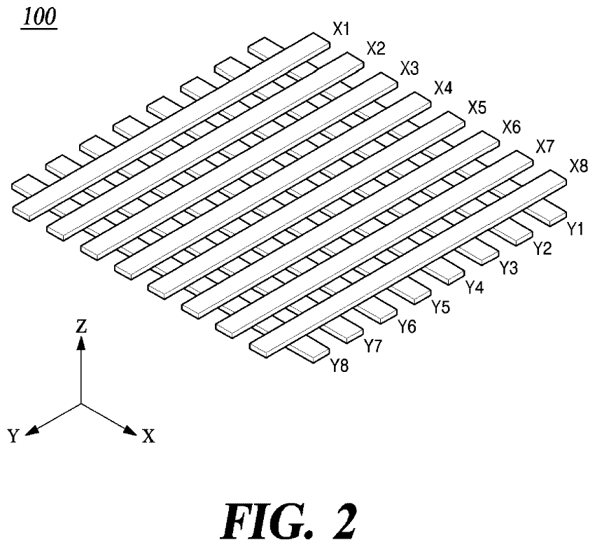

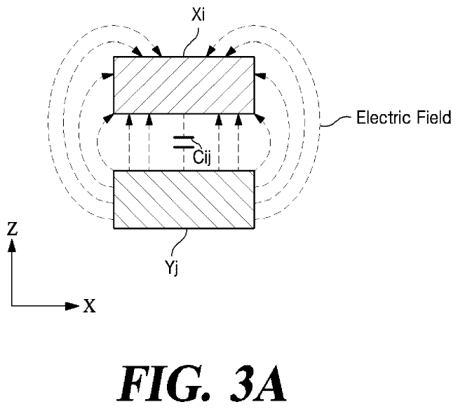

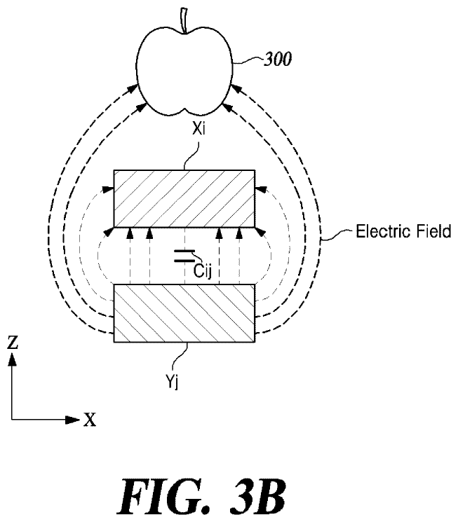

FIG. 2 is a diagram illustrating an electrode array according to an embodiment of the present disclosure. FIGS. 3A and 3B are diagrams referenced to explain mutual capacitance formed between a drive electrode and a sense electrode according to an embodiment of the present disclosure.

As shown in FIG. 2, the electrode array 100 may include one or more drive electrodes Y1 to Y8 and one or more sense electrodes X1 to X8. The electrode array 100 may be configured along an X-axis and a Y-axis. The drive electrodes Y1 to Y8 may be arranged and spaced apart from each other in a Y-axis direction. Each of the drive electrodes Y1 to Y8 may extend in an X-axis direction. The sense electrodes X1 to X8 may be arranged and spaced apart from each other in the X-axis direction. Each of the sense electrodes X1 to X8 may extend in the Y-axis direction. The sense electrodes X1 to X8 may be arranged to be spaced apart from the drive electrodes Y1 to Y8 in a Z-axis direction.

Mutual capacitance is a capacitance value generated between the drive electrodes Y1 to Y8 and the sense electrodes X1 to X8. For example, referring to FIG. 3A, when a drive signal is applied to a j-th drive electrode Yj, a mutual capacitance Cij may be formed between the j-th drive electrode Yj and an i-th drive electrode Xi. Referring to FIG. 3B, when an object 300 contacts the sense electrode Xi, an electric field formed between the drive electrode Yj and the sense electrode Xi changes due to a dielectric constant of the object 300, and accordingly, the capacitance value Cij between the two electrodes Yj and Xi is changed. The object recognition device 10 may determine an object on the electrode array 100 using a combination of mutual capacitance that changes depending on the object positioned over the electrode array 100 based on the characteristics described above. When an object (e.g., an apple) is placed on the electrode array 100 including the X-Y axis, different mutual capacitance values are formed depending on a contact portion, which is detected by the object recognition device 10 to generate a pulse train.

To this end, the drive circuit 120 for inducing mutual capacitance may be connected to the drive electrodes Y1 to Y8, and the sensing circuit 140 for generating a pulse train by detecting the mutual capacitance may be connected to the sense electrodes X1 to X8.

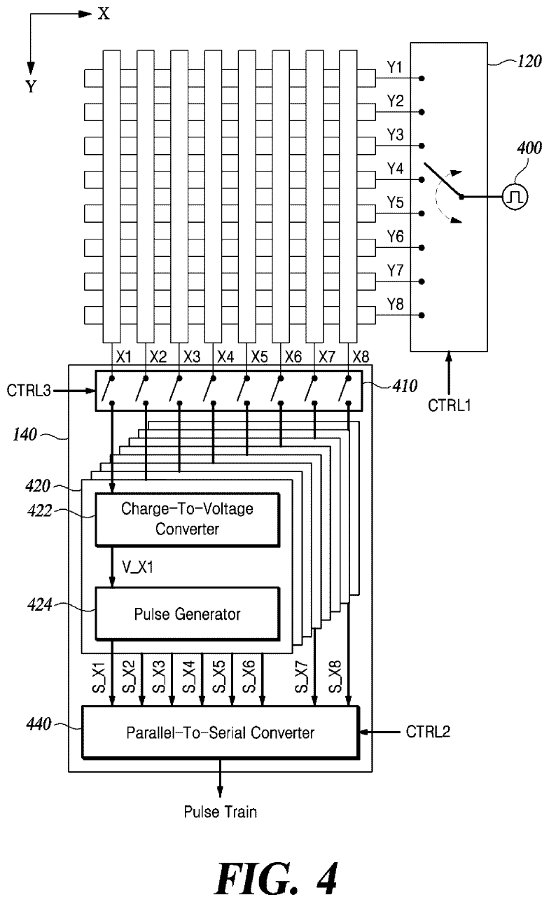

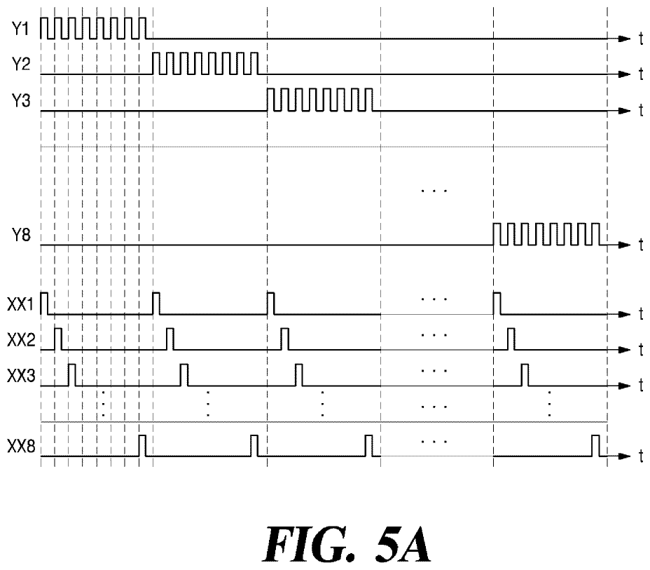

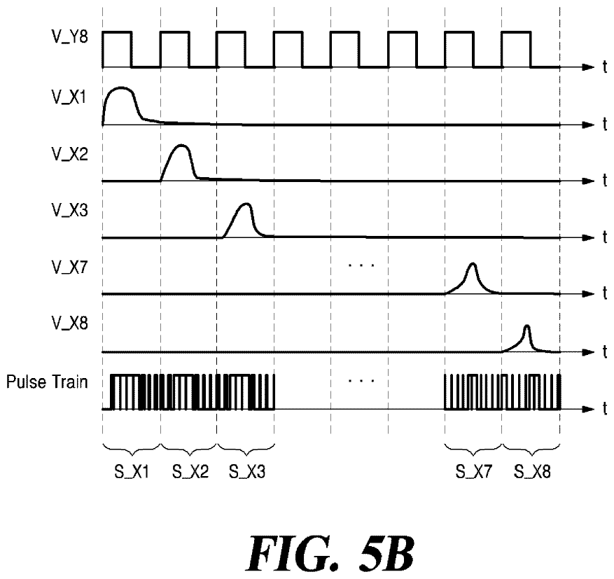

FIG. 4 is a diagram schematically illustrating a drive circuit and a sensing circuit according to an embodiment of the present disclosure. FIGS. 5A and 5B are waveform diagrams referenced to explain the operation of the drive circuit and the sensing circuit according to an embodiment of the present disclosure.

The drive circuit 120 may supply a drive signal 400 for inducing mutual capacitance to the drive electrodes Y1 to Y8. The drive signal 400 may be a square wave having a pulse shape.

The drive circuit 120 may apply the drive signal 400 to one of the plurality of drive electrodes Y1 to Y8 during a specific time period. For example, referring to FIG. 5A, the drive circuit 120 may sequentially apply the drive signal 400 to the plurality of drive electrodes Y1 to Y8. The operation of the drive circuit 120 may be controlled by the first control signal CTRL1 supplied from the controller 160. For example, the first control signal CTRL1 may indicate a timing for changing a drive electrode to which the drive signal 400 is to be applied and/or may indicate to which drive electrode the drive signal 400 is to be applied. The length of a time period during which the drive signal 400 is applied to each of the plurality of drive electrodes Y1 to Y8 may be set in consideration of the number of sense electrodes X1 to X8.

The sensing circuit 140 may include a plurality of X-axis capacitive sensors 420 and a parallel-to-serial converter 440. The plurality of X-axis capacitive sensors 420 may be provided to correspond to the plurality of sense electrodes X1 to X8.

Each of the X-axis capacitive sensors 420 may include a charge-to-voltage converter 422 for converting capacitance changed in the connected sense electrodes X1 to X8 into voltage signals V_X1 to V_X8 and a pulse generator 424 generating pulse trains S_X1 to S_X8 based on the converted voltage signals V_X1 to V_X8. The charge-to-voltage converter 422 may include, for example, an amplifier equipped with a capacitor in a feedback path and a buffer capacitor connected to an input terminal of the amplifier. The charge-to-voltage converter 422 may convert a change in charge voltage of the buffer capacitor into an analog signal, such as a voltage signal. The pulse generator 424 performs pulse modulation, such as Pulse Width Modulation (PWM) or Sigma-Delta Modulation (SDM), on an output signal from the charge-to-voltage converter 422 to generate the pulse trains S_X1 to S_X8 corresponding to a mutual capacitance value. In the present disclosure, the pulse trains S_X1 to S_X8 generated by the X-axis capacitive sensors 420 may be referred to as sub-pulse trains.

The parallel-to-serial converter 440 may convert the sub-pulse trains S_X1 to S_X8 generated respectively by the X-axis capacitive sensors 420 into a single pulse train. The parallel-to-serial converter 440 may be implemented as, for example, a switching circuit alternatively connected to any one of the X-axis capacitive sensors 420. The operation of the parallel-to-serial converter 440 may be controlled by a second control signal CTRL2 supplied from the controller 160. For example, the second control signal CTRL2 may indicate a switching timing and/or indicate which of X-axis capacitive sensors 420 is to be connected at a current time. The length of a time period during which each of the X-axis capacitive sensors 420 is electrically connected to an output terminal of the parallel-to-serial converter 440 may correspond to a period of the drive signal 400.

The sensing circuit 140 may further include a switching circuit 410 for sequentially sensing mutual capacitance formed for each of the plurality of sense electrodes X1 to X8. The operation of the switching circuit 410 may be controlled by a third control signal CTRL3 supplied from the controller 160. Referring to FIG. 5A, the third control signal CTRL3 is a control signal for applying an individual signal to each of the sense electrodes X1 to X8 and may generate signals XX1 to XX8. The generated signals are transferred to the X-axis capacitive sensors 420, respectively and may be converted into voltage signals V_X1 to V_X8 by the charge-to-voltage converter 422.

FIG. 5B illustrates an operation of the sensing circuit 140 when the drive signal 400 is applied to the eighth drive electrode Y8. Assuming that a mutual capacitance is formed between the eighth drive electrode Y8 and each of the sense electrodes X1 to X8 by an object in contact with the electrode array 100, the drive signal 400 is converted into different types of voltage waveforms V_X1 to V_X8 by a changed mutual capacitance. For example, the first voltage waveform V_X1 may have a shape corresponding to the mutual capacitance value between the eighth drive electrode Y8 and the first sense electrode X1, the second voltage waveform V_X2 may have a shape corresponding to the mutual capacitance value between the eighth drive electrode Y8 and the second sense electrode X2, the third voltage waveform V_X3 may have a shape corresponding to the mutual capacitance value between the eighth drive electrode Y8 and the third sense electrode X3, and similarly, the seventh voltage waveform V_X7 may have a shape corresponding to the mutual capacitance value between the eighth drive electrode Y8 and the seventh sense electrode X7, and the eighth voltage waveform V_X8 may have a shape corresponding to the mutual capacitance value between the eighth drive electrode Y8 and the eighth sense electrode X8. Each voltage waveform V_X1 to V_X8 undergoes a predetermined pulse modulation to generate corresponding sub-pulse trains S_X1 to S_X8, and the sub-pulse trains S_X1 to S_X8 may be combined in a predetermined order to form one pulse train. To this end, the X-axis capacitive sensors 420 may operate in different time periods. For example, the first X-axis capacitance sensor may generate a sub-pulse train S_X1 corresponding to a mutual capacitance value between the eighth drive electrode Y8 and the first sense electrode X1 in a first cycle of the drive signal 400 applied to the eighth drive electrode Y8, the second X-axis capacitance sensor may generate a sub-pulse train S_X2 corresponding to a mutual capacitance value between the eighth drive electrode Y8 and the second sense electrode X2 in a second cycle of the drive signal 400 applied to the eighth drive electrode Y8, and similarly, the eighth X-axis capacitance sensor may generate a sub-pulse train S_X8 corresponding to a mutual capacitance value between the eighth drive electrode Y8 and the eighth sense electrode X8 in an eighth cycle of the drive signal 400 applied to the eighth drive electrode Y8.

The pulse train generated by the sensing circuit 140 may be provided to the neuron network processor 180, and the neuron network processor 180 may determine an object placed on the electrode array 100 based on an artificial neuron network. The artificial neuron network may be, for example, a spike neuron network (SNN) that processes spike inputs.

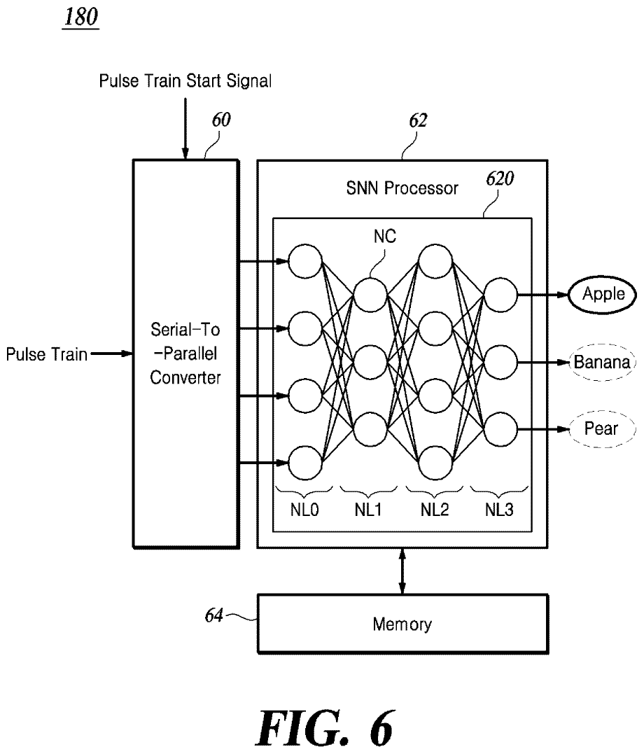

FIG. 6 is a diagram schematically illustrating the neuron network processor according to an embodiment of the present disclosure.

As shown in FIG. 6, the neuron network processor 180 may include all or some of a serial-to-parallel converter 60, an SNN processor 62, and a memory 64. Not all blocks shown in FIG. 6 are essential elements, and some blocks may be added, changed, or deleted in other embodiments. Meanwhile, the components shown in FIG. 6 represent functionally distinct elements, and at least one component may be implemented in an integrated form in an actual physical environment.

The SNN processor 62 may perform various operations based on an SNN 620. The SNN 620 may include a plurality of neuron layers NL0 to NL3. For example, the SNN 620 may include an input neuron layer NC0, one or more hidden neuron layers NC1 and NC2, and an output neuron layer NC3. Each of the neuron layers NL0 to NL3 may include one or more neuron circuits NC. Each neuron circuit NC may operate based on spike signals. The spike signal may be a spike or pulse signal that fires for a short period of time.

The SNN processor 62 may include an operator or accelerator to process operations based on the SNN 620. The SNN processor 62 may train the SNN 620 or perform inference using the SNN 620 based on trained weights. In the present disclosure, it is assumed that the SNN processor 62 is implemented as hardware specialized for neuron network operations (e.g., a neuromorphic processor), but the disclosure is not limited thereto. In another example, the SNN processor 62 may be implemented as a general-purpose processor, and operations for the SNN 620 may be executed by software.

The SNN processor 62 may process signals and information in a manner similar to that of a biological neuron network. For example, the SNN processor 62 may include components corresponding to neurons, synapses, etc. of a biological neuron network. Each of the components of the SNN processor 62 may perform functions similar to those of components of the biological neuron network.

The serial-to-parallel converter 60 may convert the pulse train input from the sensing circuit 140 into a form that may be processed by the SNN 620. For example, the serial-to-parallel converter 60 may parallelize a 1-bit pulse train into a plurality of input spike signals. The serial-to-parallel converter 60 may convert the pulse train based on a pulse train start signal. The pulse train start signal may be input from the controller 160, for example. The pulse train start signal may be a signal indicating a start timing of the sub-pulse train corresponding to a specific combination of the drive electrode and the sense electrode. For example, the pulse train start signal may be a square wave signal that rises and/or falls at a point corresponding to the boundary between different sub-pulse trains within the pulse train.

The memory 64 may store data or information necessary for the SNN processor 62 to perform operations. For example, the memory 64 may store weights set for training for object recognition.

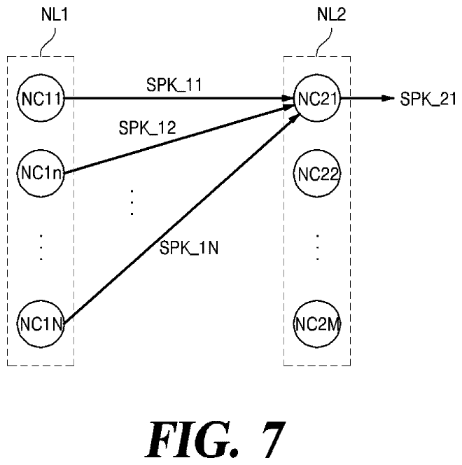

FIG. 7 is a diagram referenced to explain a neuron layer according to an embodiment of the present disclosure.

Each of neuron layers NL0 to NL3 may include one or more neuron circuits. For example, referring to FIG. 7, a first hidden neuron layer NL1 may include N neuron circuits NC11 to NCIN (N is a natural number), and a second hidden neuron layer NL2 may include M neuron circuits NC22 to NC2M (M is a natural number).

The neuron circuits NC11 to NCIN of the first hidden neuron layer NL1 may output spike signals SPK_11 to SPK_1N to neuron circuits NC21 to NC2M of the second hidden neuron layer NL2. For example, the spike signals SPK_11 to SPK_IN output from the neuron circuits NC11 to NCIN of the first neuron layer may each be input to the first neuron circuit NC21 of the second neuron layer NL2. The first neuron circuit NC21 of the second neuron layer NL2 may determine whether to fire, a firing timing, and/or a firing cycle based on the input spike signals SPK_11 to SPK_IN. The first neuron circuit NC21 of the second neural layer NL2 may generate an output spike signal SPK_21 based on the determined firing status, firing timing, and/or firing cycle.

For simplicity, only the connection relationship between the neuron circuits NC11 to NCIN of the first hidden neuron layer NL1 and the first neuron circuit NC21 of the second hidden neuron layer NL2 has been described above, but the scope of the present disclosure is not limited thereto. For example, the aforementioned connection relationship may be similarly applied between neuron circuits NC11 to NCIN of the first hidden neuron layer NL1 and other neuron circuits NC22 to NC2M of the second hidden neuron layer NL2, and/or between neuron circuits of other adjacent neuron layers (e.g., a neuron circuit of an i-th hidden neuron layer and a neuron circuit of an i+1-th hidden neuron layer).

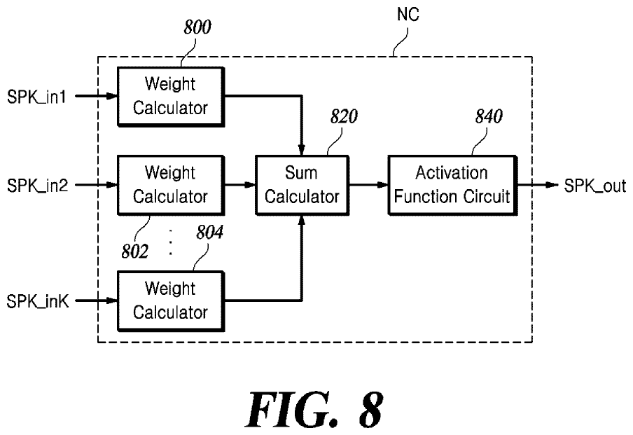

FIG. 8 is a diagram referenced to explain a neuron circuit according to an embodiment of the present disclosure.

The neuron circuit NC may include all or some of one or more weight calculators 800 to 804, a sum calculator 820, and an activation function circuit 840. Not all blocks shown in FIG. 8 are essential elements, and some blocks may be added, changed, or deleted in other embodiments. Meanwhile, the components shown in FIG. 8 represent functionally distinct elements, and at least one component may be implemented in an integrated form in an actual physical environment.

The weight calculators 800 to 804 may calculate weights and input values set for training for object recognition.

Each of the weight calculators 800 to 804 may receive spike signals SPK_in1 to SPK_inK (K is a natural number) and may provide weights to the input spike signals SPK_in1 to SPK_inK.

The weight calculators 800 to 804 may receive spike signals provided from neuron circuits of a neuron layer (e.g., a k-th hidden neuron layer or an input neuron layer) preceding a neuron layer (e.g., a k+1-th hidden neuron layer (k is a natural number)) to which the neuron circuit NC belongs. For example, when the neuron circuit NC belongs to the second neuron layer NL2 shown in FIG. 7, the spike signals SPK_in1 to SPK_inK may correspond to spike signals SPK_11 to SPKIN output from neuron circuits NC11 to NCIN of the first hidden neuron layer NL1.

The weight calculators 800 to 804 may receive spike signals SPK_in1 to SPK_inK provided from different neuron circuits. For example, the first weight calculator 800 may receive a first input spike signal SPK_in1 provided from a first neuron circuit of the preceding neuron layer, the second weight calculator 802 may receive a second input spike signal SPK_in2 provided from the second neuron circuit of the preceding neuron layer, and similarly, the K-th weight calculator 804 may receive a K-th input spike signal SPK_in2 provided from the K-th neuron circuit of the preceding neuron layer.

The weight calculators 800 to 804 may apply weights, which are preset through the training process, to the spike signals SPK_in1 to SPK_inK. For example, the first weight calculator 800 may apply a weight of W1 to the first input spike signal SPK_in1, the second weight calculator 802 may apply a weight of W2 to the second input spike signal SPK_in2, and similarly, the K-th weight calculator 804 may apply a weight of WK to the K-th input spike signal SPK_inK. The weights applied to spike signals SPK_in1 to SPK_inK may vary over time. For example, a relatively large weight value may be given to the spike signals SPK_in1 to SPK_inK input during a time period adjacent to a predetermined reference time period, and a relatively small weight value may be given to the spike signals SPK_in1 to SPK_inK input during a time period far from the reference time period.

The weight applied to the spike signals SPK_in1 to SPK_inK may indicate the strength of connection between the neuron circuit NC and preceding neuron circuits of the preceding neuron layer. The weight calculators 800 to 804 and the weight may be referred to as synapse and a synapse weight, respectively.

The sum calculator 820 sums the values calculated at each synapse.

The sum calculator 820 may accumulate spike signals in which the weights are reflected. As an example, when the neuron circuit NC performs a reinforcement operation, the sum calculator 820 may increase the accumulated signal by the weight corresponding to the input spike signals SPK_in1 to SPK_inK at a point at which each of the input spike signals SPK_in1 to SPK_inK is fired. As another example, when the neuron circuit NC performs an inhibition operation, the sum calculator 820 may reduce the accumulated signal by the weight corresponding to the input spike signals SPK_in1 to SPK_inK at a point at which each of the input spike signals SPK_in1 to SPK_inK is fired.

The sum calculator 820 may be implemented as a digital circuit, an analog circuit, or combinations thereof. As an example, the sum calculator 820 may be implemented through an operation device, such as a shifter, an adder, an accumulator, or a counter. In another example, the sum calculator 820 may be implemented as a capacitor, and in this case, the signal accumulated in the sum calculator 820 may be an amount of charge.

The activation function circuit 840 may generate an output spike signal SPK_out that is fired when a condition equal to or higher than a threshold is satisfied. If the signal accumulated in the sum calculator 820 is higher than a threshold level, the neuron circuit NC may be fired. For example, the activation function circuit 840 may toggle the output spike signal SPK_out for a short period of time when the amount of signals accumulated in the sum calculator 820 is equal to or greater than the threshold level. As an example, the activation function circuit 840 may include a comparator that compares the signal accumulated in the sum calculator 820 with a threshold level and a pulse generator activated based on an output from the comparator, but is not limited to these examples.

The output spike signal SPK_out of the neuron circuit NC included in the hidden neuron layer may be input to the neuron circuit of a subsequent neuron layer. In another example, in the case of the output spike signal SPK_out of the neuron circuit NC included in the output neuron layer, the shape and/or type of an object on the electrode array may be estimated based on the corresponding spike signal SPK_out. For example, referring to FIG. 6, the output neuron layer NL3 may include output neuron circuits corresponding to candidate classes of an object to be recognized. The candidate classes of an object may reflect not only primary attributes regarding the object itself, but also detailed attributes. For example, separate candidate classes may be prepared depending on the type of substance in the object, such as ‘cup containing water’ and ‘cup containing juice’.

Meanwhile, in FIG. 6, one output neuron circuit is shown for each candidate class, but a plurality of output neuron circuits may be provided for one candidate class. The SNN processor 62 may classify an object placed on the electrode array based on the spike signal output by the output neuron circuit corresponding to each candidate class. As an example, the SNN processor 62 may estimate a candidate class corresponding to an output neuron circuit that is fired fastest as a class of the object. As another example, the SNN processor 62 may estimate a candidate class corresponding to an output neuron circuit that fires the most as the class of the object. As another example, the SNN processor 62 may estimate a candidate class corresponding to the output neuron circuit that fires a preset threshold or more as the class of the object.

As described above, according to embodiments of the present disclosure, different capacitance values generated at the electrodes at each position of the electrode array 100 are changed into voltage values, and the corresponding pulse train is generated according to the form of the output voltage value. The pulse train having spatial information and material information formed from the electrode array 100 may pass through synapses and neurons having trained weights, and an output neuron may recognize an object on the electrode array 100 to generate a final result. In addition, according to embodiments of the present disclosure, even if the object placed on the electrode array 100 is a cup, not only the object called a cup is read, but also the cup has different dielectric constants depending on a liquid contained in the cup, and thus, whether the cup contains water or juice may also be determined. This makes it possible to read a variety of information by obtaining not only a one-dimensional object recognition result but also the degree of other substances contained in the object.

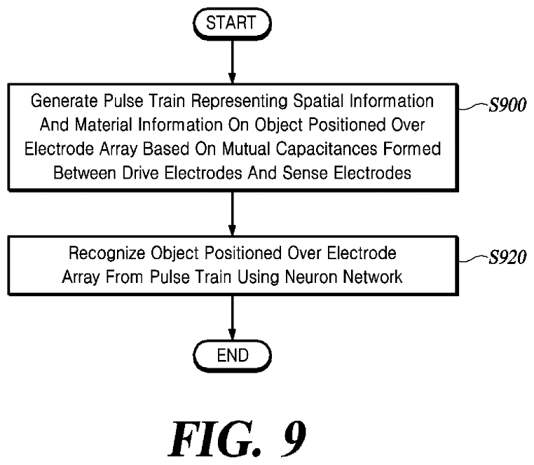

FIG. 9 is a flowchart illustrating an operation of an object recognition device according to an embodiment of the present disclosure.

The object recognition device 10 generates a pulse train representing spatial information and material information on the object positioned over the electrode array based on mutual capacitances formed between a plurality of drive electrodes and a plurality of sense electrodes (S900). The plurality of drive electrodes may be arranged in a first direction (e.g., an X-axis direction), and the plurality of sense electrodes may be arranged in a second direction (e.g., a Y-axis direction) perpendicular to the first direction. The plurality of sense electrodes may be arranged to be spaced apart from the plurality of drive electrodes in a third direction (e.g., a Z-axis direction) perpendicular to the first and second directions.

In operation S900, the object recognition device 10 may selectively apply a drive signal to one of the plurality of drive electrodes during a certain time period. For example, the object recognition device 10 may sequentially apply a drive signal to the plurality of drive electrodes based on a predetermined order. The drive signal may be a square wave signal. The object recognition device 10 may apply a drive signal to a specific drive electrode during a time period corresponding to the number of the plurality of sense electrodes. For example, in the object recognition device 10, the number of cycles of the drive signal applied to each drive electrode may be equal to the number of the plurality of sense electrodes.

In operation S900, the object recognition device 10 may generate a sub-pulse train corresponding to a value of mutual capacitance formed for each of the plurality of sense electrodes. The object recognition device 10 may include a charge-to-voltage converter and a pulse generator provided at each of the plurality of sense electrodes. The object recognition device 10 may convert a value of mutual capacitance formed between a sense electrode to which the charge-to-voltage converter is connected and a specific drive electrode into voltage using the charge-to-voltage converter. The object recognition device 10 may generate a sub-pulse train corresponding to the converted voltage (i.e., the value of mutual capacitance) using the pulse generator. For example, the pulse generator may perform Pulse Width Modulation (PWM) or Sigma-Delta Modulation (SDM) on the output of the charge-to-voltage converter. The object recognition device 10 may serialize the generated sub-pulse trains into a single pulse train. Mutual capacitances formed between the plurality of drive electrodes and the plurality of sense electrodes may vary depending on the shape and dielectric constant of the object on the electrode array. The pulse train generated by the object recognition device 10 may include one or more pulses, and the number of pulses, an interval between pulses, and a pulse width of each pulse may vary depending on the shape and dielectric constant of the object on the electrode array.

The object recognition device 10 recognizes the object on the electrode array from the pulse train using a neuron network (S920). Recognizing an object may include estimating at least one of the shape and type of the object. Recognizing an object may include further inferring the types of different substances included in the object. For example, when the object placed on the electrode array is a cup, the object recognition device 10 may distinguish whether the cup contains water or juice.

In operation S920, the object recognition device 10 may input spike signals converted from the pulse train to a spike neuron network (SNN). The SNN may include an input neuron layer, one or more hidden neuron layers, and an output neuron layer.

The input neuron layer may include one or more input neuron circuits that transmit the input spike signal to a first hidden neuron layer. The object recognition device 10 may generate spike signals to be input to each of one or more input neuron circuits based on the pulse train. The pulse train may be a 1-bit pulse train in which a plurality of sub-pulse trains corresponding to different combinations of drive electrodes and sense electrodes are serialized in a predetermined order. The object recognition device 10 may re-parallelize the corresponding pulse train based on a pulse train start signal indicating a timing at which each of the plurality of sub-pulse trains is incorporated into (or reflected in) the pulse train.

Each of the one or more hidden neuron layers may include one or more hidden neuron circuits that process spike signals output from a preceding neuron layer.

Each of the one or more neuron circuits (e.g., each hidden neuron circuit) may include one or more weight calculators, a sum calculator, and an activation function circuit corresponding to different neuron circuits of the preceding neuron layer. Each weight calculator may assign a pre-trained weight to the spike signal input from a specific neuron circuit of the preceding neuron layer. The sum calculator may accumulate values calculated in one or more weight calculators. The activation function circuit may generate an output spike signal to be provided to a subsequent neuron layer. The output spike signal may be selectively fired, for example, based on whether the value accumulated in the sum calculator is greater than or equal to a preset threshold.

The output neuron layer may include a plurality of output neuron circuits respectively corresponding to a plurality of object classes. The object recognition device 10 may estimate an object class corresponding to the object positioned over the electrode array based on the number of occurrences of spikes of the output spike signal of each output neuron circuit.

According to an embodiment of the present disclosure, spatial information and material information on an object may be identified from a mutual capacitance value formed in an electrode array by using the characteristics of each object having a different shape and dielectric constant. In addition, by converting the identified information into a spike signal in real time and transmitting the spike signal to a spike neuron network (SNN), an object may be recognized with low power.

According to an embodiment of the present disclosure, a new type of information on the shape and material of an object may be provided based on capacitance values obtained from an electrode array. Accordingly, information capable of recognizing objects may be transmitted to a neuron network even with less data than an image-based spike encoding method.

According to an embodiment of the present disclosure, information on other substances (for example, a type of liquid inside a cup) included in a corresponding object, as well as a one-dimensional object recognition result for an object placed on an electrode array, may be additionally obtained.

According to an embodiment of the present disclosure, only less input and output signals (e.g., 1 bit of pulse sequence and a pulse sequence start signal of a value generated in each electrode) than an address-event representation (AER) interface requiring input/output signals of neuron address information, REQ, and ACK to use the SNN, thereby facilitating connection with the SNN.

The features of the present disclosure are not limited to the features mentioned above, and other features not mentioned may be clearly understood by those skilled in the art from the description below.

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM

(EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Accordingly, one of ordinary skill would understand that the scope of the claimed invention is not to be limited by the above explicitly described embodiments but by the claims and equivalents thereof.

What is claimed is:

1. An object recognizing device comprising:
an electrode array including a plurality of drive electrodes and a plurality of sense electrodes;
a sensing circuit configured to generate a pulse train representing spatial information and material information on an object positioned over the electrode array based on mutual capacitances formed between the plurality of drive electrodes and the plurality of sense electrodes; and
a neuron network processor configured to recognize the object positioned over the electrode array based on the pulse train.

2. The object recognizing device of claim 1, wherein the sensing circuit includes:
a plurality of X-axis capacitive sensors respectively connected to the plurality of sense electrodes, wherein each of the X-axis capacitive sensors is configured to generate sub-pulse train corresponding to a value of mutual capacitance formed for a connected sense electrode; and
a parallel-to-serial converter configured to serialize sub-pulse trains respectively generated by the plurality of X-axis capacitive sensors into the pulse train.

3. The object recognizing device of claim 2, wherein the each of the plurality of X-axis capacitive sensors includes:
a charge-to-voltage converter configured to convert the value of mutual capacitance formed for the connected sense electrode into voltage; and
a pulse generator configured to generate the sub-pulse train corresponding to the converted voltage.

4. The object recognizing device of claim 3, wherein the pulse generator performs pulse Width Modulation (PWM) or Sigma-Delta Modulation (SDM) on an output of the charge-to-voltage converter.

5. The object recognizing device of claim 1, wherein:
the neuron network processor inputs spike signals converted from the pulse train to a spike neuron network (SNN) including an input neuron layer, one or more hidden neuron layers, and an output neuron layer, and
each of the one or more hidden neuron layers includes one or more hidden neuron circuits configured to process spike signals output by a preceding neuron layer.

6. The object recognizing device of claim 5, wherein:
the input neuron layer includes one or more input neuron circuits, wherein each of the one or more input neuron circuits is configured to transmit an input spike signal to a first hidden neuron layer, and
the neuron network processor includes a serial-to-parallel converter configured to generate input spike signals of the one or more input neuron circuits based on the pulse train.

7. The object recognizing device of claim 6, wherein:
the pulse train is a 1-bit pulse train in which a plurality of sub-pulse trains corresponding to different combinations of drive electrodes and sense electrodes are serialized in a predetermined order, and
the serial-to-parallel converter re-parallelizes the pulse train based on a pulse train start signal that indicates a timing at which each of the plurality of sub-pulse trains is incorporated into the pulse train.

8. The object recognizing device of claim 5, wherein each of the one or more hidden neuronal circuits includes:
one or more weight calculators configured to apply a pre-trained weight to spike signals input from different neuron circuits of the preceding neuron layer;
a sum calculator configured to accumulate values calculated by the one or more weight calculators; and
an activation function circuit configured to generate an output spike signal selectively fired based on whether the value accumulated by the sum calculator is greater than or equal to a preset threshold.

9. The object recognizing device of claim 5, wherein:
the output neuron layer includes a plurality of output neuron circuits respectively corresponding to a plurality of object classes, and
the neuron network processor estimates an object class corresponding to the object positioned over the electrode array, based on the number of occurrences of spikes of an output spike signal of each output neuron circuit.

10. The object recognizing device of claim 1, wherein the neuron network processor estimates a shape and/or a type of the object.

11. The object recognizing device of claim 10, wherein the neuron network processor further estimates a type of other substances contained in the object.

12. The object recognizing device of claim 1, wherein the mutual capacitances vary depending on a shape and a dielectric constant of the object positioned over the electrode array.

13. The object recognizing device of claim 1, wherein:
the pulse train includes one or more pulses, and
a number of the one or more pulses, an interval between the one or more pulses, and a pulse width of each pulse vary depending on a shape and a dielectric constant of the object on the electrode array.

14. The object recognizing device of claim 1, further comprising:
a drive circuit configured to selectively apply a drive signal to one of the plurality of drive electrodes.

15. The object recognizing device of claim 14, wherein:
the drive signal is a square wave signal, and
the drive circuit applies the drive signal to one of the plurality of drive electrodes during a time period corresponding to the number of the plurality of sense electrodes.

16. The object recognizing device of claim 14, wherein the drive circuit sequentially applies the drive signal to the plurality of drive electrodes based on a predetermined order.

17. The object recognizing device of claim 1, wherein:
the plurality of drive electrodes are arranged in a first direction, and
the plurality of sense electrodes are arranged in a second direction perpendicular to the first direction.

18. The object recognizing device of claim 17, wherein the plurality of sense electrodes are arranged to be spaced apart from the plurality of drive electrodes in a third direction perpendicular to the first direction and the second direction.

19. An operating method of an object recognizing device including an electrode array including a plurality of drive electrodes and a plurality of sense electrodes, the operating method comprising:
generating a pulse train representing spatial information and material information on an object positioned over the electrode array based on mutual capacitances formed between the plurality of drive electrodes and the plurality of sense electrodes; and
recognizing the object positioned over the electrode array from the pulse train using a neuron network.

20. A device of generating an input signal for recognizing an object based on a spike neuron network, the device comprising:
an electrode array including a plurality of drive electrodes and a plurality of sense electrodes; and
a sensing circuit configured to generate a pulse train representing spatial information and material information on an object positioned over the electrode array based on mutual capacitances formed between the plurality of drive electrodes and the plurality of sense electrodes and provide the generated pulse train as an input of a device performing operation of the spike neuron network.
